(19) United States
(12) Patent Application Publication
(10) Pub. No.: US 2004/0203637 A1
(43) Pub. Date: Oct. 14, 2004

(54) Method and apparatus for remotely accessing three-party calling functions

(76) Inventor: Uday Dodla, Irving, TX (US)

Correspondence Address: STEVEN B. PHILLIPS, MOORE & VAN ALLEN, SUITE 800, 2200 WEST MAIN STREET, DURHAM, NC, 27705, US

(21) Appl. No.: 10/135,249

(22) Filed: Apr. 30, 2002

(51) Int. Cl. H04Q 7/20; H04M 11/00; H04M 3/42

(52) U.S. Cl. 455/414.1; 455/403

(57) ABSTRACT

Method and apparatus for remotely accessing three-party calling functions. Remote access is provided for three-party calling functions, including conference calling. A remote user calls into the system. The remote user establishes a first connection with a second party. The system listens for a special voice command, or a dual tone multi-frequency (DTMF) sequence, or an individual DTMF signal from a special key on a wireless phone that works in both enterprise and cellular modes. The remote user then issues commands to invoke the three-party calling function. The communication system establishes a second connection to at least a third party. The system executes the three-party calling function upon receiving a selection from the remote user. In some embodiments, the three-party calling functions are implemented by a mobility server within the communication system.

### BACKGROUND OF THE INVENTION

It is known to allow users outside an office to place calls in a fashion similar to how calls would be made from inside the office. A remote user may log onto an enterprise or office-based communication system that allows the user to place calls through the office communications system. Typically a “personal assistant” manages access to the system by remote users, and a “mobility server” carries out some functions remotely in order to allow remote users to make use of an enterprise PBX or cellular radio exchange. The personal assistant may use pass-words to verify the identity of a remote user.

An arrangement such as described above is often used to enable remote users to call into the system to access messages, or connect with users in the enterprise. It might also be used to allow remote users to make toll calls where the expense of the call is to be born by the enterprise. Remote access to specialized functions is limited, at least in part because the remote user does not have a terminal capable of digitally signaling the enterprise system in the way enterprise terminals do through the use of special function keys

### BRIEF SUMMARY OF THE INVENTION

The present invention provides remote access to special functions typically present in an enterprise type communication system. The functions to which access is provided are so called, “three party calling” functions which require what would otherwise be a two-party call to be connected with a third, and possibly more parties. A typical example of a three-party calling function would be a three-way or conference call, but three-party calling functions can also include call transfer, call hold, and other such features.

According to at least some embodiments of the invention, a remote user calls into the system and goes through the identification/authentication process. The remote user then establishes a first connection with a second party. The system may be “listening” for a special voice command, or a dual tone multi-frequency (DTMF) or “touch tone” sequence, or an individual DTMF signal from a special key on a wireless phone that works in both enterprise and cellular modes. The remote user then issues the command to invoke the three-party calling function. This command is received by the communication system, which will typically then prompt the user. The user then issues another command, which includes or consists of an identifier corresponding to a third party. In many cases this identifier will be a telephone number. The communication system receives this command and establishing a second connection between at least the identified remote user and the third party. The system confirms this second connection and listens for another command from the remote user to select the three-party function. The system executes the three-party calling function upon receiving the selection.

In some embodiments, the communication system in which the invention is implemented includes at least one private exchange operable to relay communication signals between users of the communication system. This exchange can be a cellular radio exchange or a so-called “private branch exchange” (PBX). Many systems will have both. A personal assistant identifies remote users and grants access to remote users to place calls through the communication system from a remote location. The system also includes a mobility server operatively interfaced to the personal assistant and exchange to provide functions to remote users, who are typically located on a public network. The mobility server in some embodiments does this through controlling the operation of the exchange.

A mobility server in some embodiments of the invention includes a first interface operable to connect to at least one private exchange. This interface will typically be implemented as a communications adapter but could take other forms. A second such interface will be operable to provide access to at least one public network, through which the remote users communicate with the server. This could be the public switched telephone network (PSTN), the public land mobile network (PLMN) or a combination or the two, or some other public network. The communication will sometimes take place through the personal assistant. The mobility server includes a processor system operable to control the operation of the server to carry out the invention. The processor system is often operated by a computer program product including a computer program comprising various instructions for carrying out the processes of the invention. The computer program instructions and the hardware within the communication system form the various means to carry out the invention in such an embodiment.

### BRIEF DESCRIPTION OF THE DRAWINGS

FIG. 1 is a block diagram that illustrates the communication system and network environment in which some embodiments of the invention are implemented.

FIG. 2 is a flowchart that shows how a user might register with the communication system to that the user can make use of the invention.

FIG. 3 is a flowchart that illustrates the invocation of a three-party calling function according to at least one embodiment of the invention.

FIG. 4 is a functional block diagram of one embodiment of a mobility server which is implementing the invention.

### DETAILED DESCRIPTION OF THE INVENTION

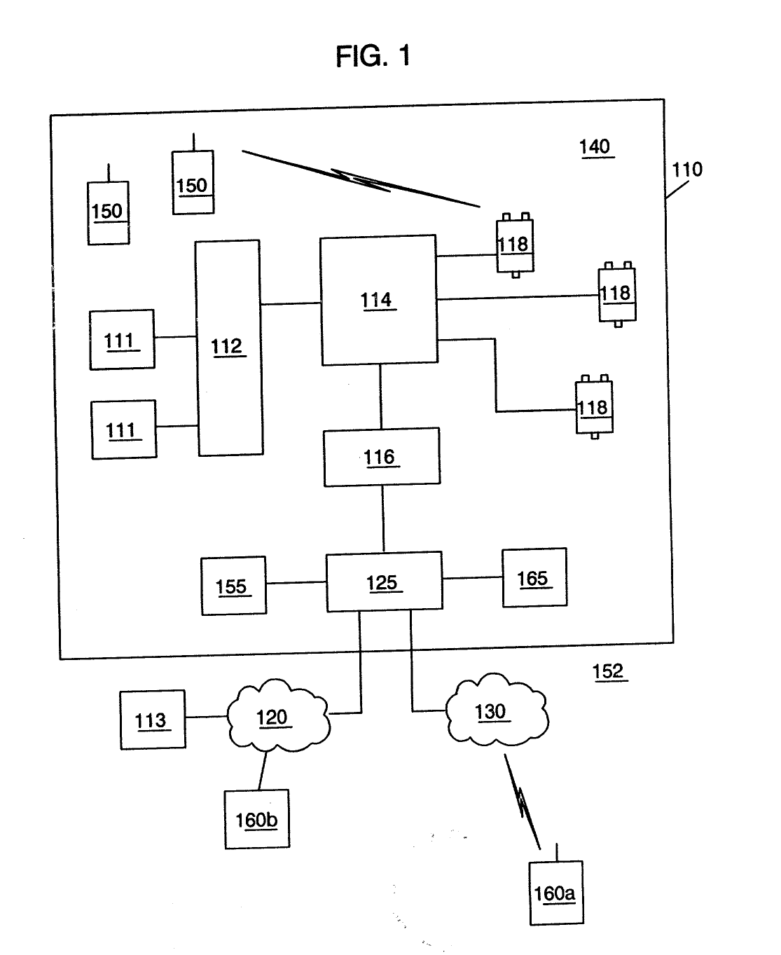

FIG. 1 is a block diagram that illustrates a communication system according to embodiments of the present invention. According to FIG. 1, a communication system 110 provides service to a local area 140, such as an office site and/or an area adjacent to the office site. Such a system is often referred to as an “enterprise” or “office” system. The communication system 110 provides service to wireless user terminals 150 and wireline user terminals 111. The communication system 110 does not provide service to a remote area 152 that is beyond the local area 140, although terminals in the remote area can access the communication system through a public network. For example, as shown in FIG. 1, the communication system 110 communicates with a public land mobile network (PLMN) 130 and a public switched telephone network (PSTN) 120. In some embodiments according to the present invention, the communication system 110 communicates with other types of public systems or networks.

The communication system 110 includes a plurality of transceivers (or radioheads) 118 that function in a manner similar to base stations in a cellular net-work. The radioheads 118 relay signals between the wireless user terminals 150 and a cellular radio exchange (CRE) 114 that handles air interface and switching functions. The communications system 110 also includes a private branch exchange (PBX) 112 that connects the CRE 114 to the wireline user terminals or telephones 111. A call by a user terminal within the local area 140 is typically initiated by transmitting a call origination message that identifies the number to which the call is directed. The origination message is received by one of the radioheads 118, and conveyed to other elements of the communication system 110 for authorization and placement of the call to its destination. For example, the wireless user terminal 150 can place a call to the wireline user terminal 111 through radiohead 118/CRE 114/PBX 112. The wireless user terminal 150 can also place calls to a remote user terminal 160a in the remote area 152 through the communication system 110 and the PSTN 120 or to a remote user terminal 160b in the remote area 152 serviced by the PLMN 130.

A mobility server 116 provides access to remote user terminals 160a and 160b that are located in the remote area 152 outside the local area 140. Among other types, a remote user terminal may be a type of wireless phone which operates with the CRE system when a user is in the local area, and switches to the PLMN when the user is located remotely. The remote user terminals 160a and 160b access the mobility server 116 by logging into a personal assistant 125 with which the remote user is registered. Once authorized by the personal assistant 125, the remote user can use the remote user terminal to place calls through the communication system 110. For example, remote user terminal 160b can place calls to user terminals that are part of PSTN 120 by logging into the personal assistant 125 and accessing the mobility server 116 which places the call to the user terminal 113 in the PSTN 120. Accordingly, the cost associated with the call placed to the user terminal 113 in the PSTN 120 from the remote area 152 can be allocated to the communications system 110 as if the call had been placed from the local area 140. As an example in accordance with the present invention, a user of remote user terminal 160a can log into the personal assistant, place a call to user terminal 113, and then initiate a conference call with the user of user terminal 113, and the user of user terminal 160b. The conference call is initiated by accessing the mobility server, 116. Additional information about the example communication system disclosed above can be found in U.S. patent application No. 09/973,432, filed Oct. 9, 2001, which is incorporated herein by reference.

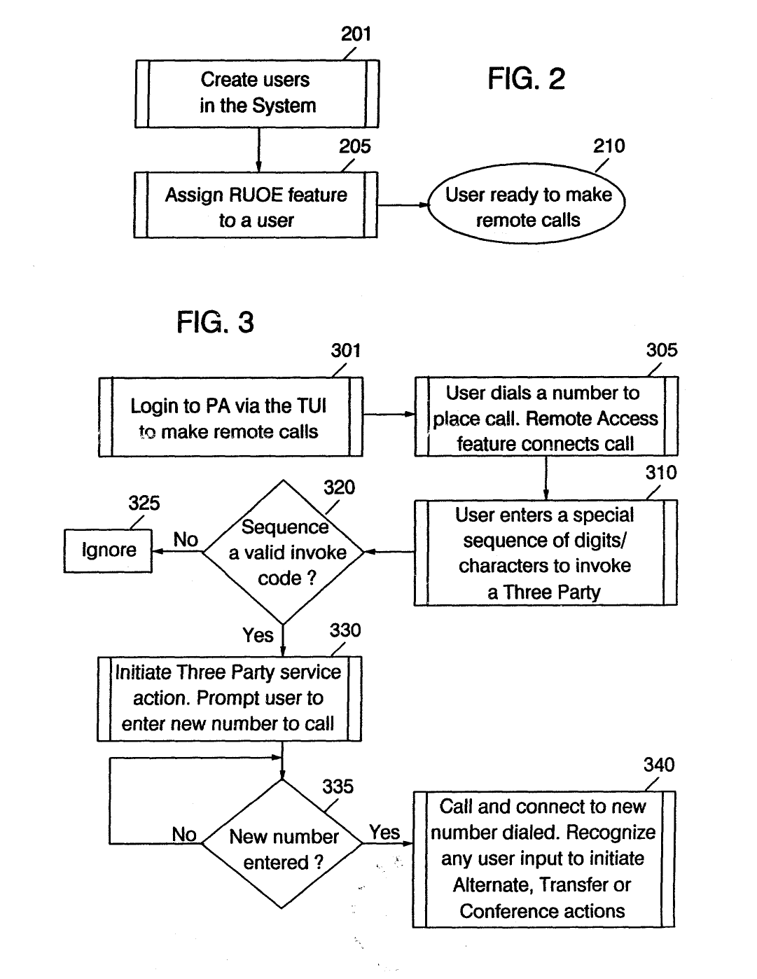

FIG. 2 is a flowchart which illustrates how the communication system, also referred to herein as an office system registers users. A three-party calling feature which can be used remotely according to the invention can also be referred to a “remote use of office extension” feature, or an RUOE feature. At step 201 of FIG. 2, a user record is created in the communication system. Typically this is done in the mobility server, and the user is associated with identifying information such as a user ID and password. The personal assistant can access this record at any time and for any purpose. Features are assigned to the user at step 205, in this case the RUOE features discussed herein. Thus, the user's record arrives at the state shown at 210, where the user can remotely access the ROUE feature.

The RUOE feature then can be assigned to any user of the office system. The identified users can make calls from remote locations just as if they were calling from inside the office communication system. The three-party calling functions are then invoked as shown in FIG. 3. The feature can be invoked while the user is already active on an existing, two-party call. The existing call need not be disconnected. At step 301, the user logs into the personal assistant using a telephone user interface (TUI). At step 305, the identified remote user enters a number to make a connection with a second party, and establish a two party call. At 310, the identified, remote user enters a special command to invoke the ROUE three-party calling features. This command can be a sequence of digits from the telephone keypad, or a keyword recognized through voice recognition.

The TUI is an audio (or voice) prompt driven menu system that is presented to the remote user when a call is placed to the personal assistant. The TUI is very similar to a call center menu that customers of some companies frequently encounter when trying to reach customer service, for example, at a credit card company. The TUI is therefore an audio presentation of the personal assistant menu. This audio presentation feature can easily be extended to be a visual presentation on a phone capable of handling this functionality in the form of a wireless web-page (i.e. advanced phones with wireless application protocol or “WAP” capability).

In some cases, where the office system is a wireless office system like that discussed herein, users are known to have cellular type phones. This might be the case where users are issued phones that can work as an enterprise radio phone, or on the PLMN. In this case, the command can be entered by pressing a single key that is peculiar to cellular type phones. There is little chance this key would be entered on a call to access voicemail systems, banking systems etc. so that there is little chance of the command being entered by accident, as in the case of single a number key. A candidate for this key might be the “Send” key, sometimes called the “Yes” key or “Call” key, since this key would never otherwise be used during a call. On some phones, this key triggers a specific DTMF tone that is not common with any other key.

In any case, if the command is the right sequence, signal, or tone, the RUOE feature recognizes the command as being used to invoke three-party calls at 320. Any sequences that are not correct are ignored at step 325. The system prompts the user to enter a new identifier for a third party to call at step 330. In this example, the identifier is a telephone number. The system collects the digits at 335 until the number has been completely entered. It should be noted that the number collection can also be accomplished by voice recognition. Also, the identifier could be a directory number such as for network based speed dial, or a similar voice key. The input of this identifier can also be referred to as a “command” in that the user is giving the system a command to call a specific number of a third party, establishing a second connection. At step 340, the system connects the call. The new call is connected simultaneously with the previous call, thus establishing a first and second connection.

The RUOE feature then allows the user to alternate between the two calls, transfer one caller to the other, or start a conference call. These user selections are enabled by providing the user with the option to select any of the above actions by entering a certain sequence of digits/characters or voice commands at step 340. The RUOE feature also allows the user to disconnect either of the two call legs and be connected to just one number if chosen, again, by entry of specialized commands that will be recognized while the system is “listening” in on the calls. It should be noted that three-party calling functions are completely initiated by the remote user. The third party need not have called into the system before the remote user can initiate the second connection.

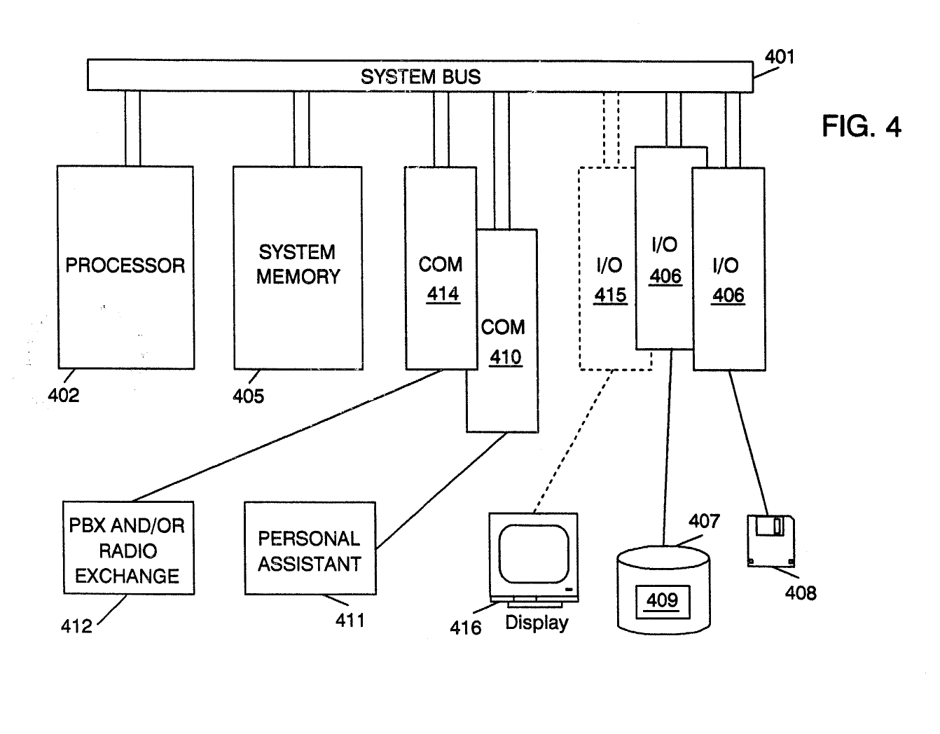

FIG. 4 illustrates an instruction execution system that serves as a mobility server in at least some embodiments of the invention. FIG. 4 illustrates the detail of a computer system that is programmed with application software to implement the functions. System bus 401 interconnects the major components. The system is controlled by microprocessor 402, which serves as the central processing unit (CPU) for the system. System memory 405 is typically divided into multiple types of memory or memory areas such as read-only memory (ROM), and random access memory (RAM). A plurality of standard input/output (I/O) adapters or devices, 406, are present. A typical system can have any number of such devices; only two are shown for clarity. These connect to various devices including a fixed disk drive, 407, and a removable media drive, 408. Computer program code instructions for implementing the appropriate functions, 409, are stored on the fixed disc, 407. When the system is operating, the instructions are partially loaded into memory, 405, and executed by microprocessor 402.

Additional I/O devices have specific functions in terms of the invention. A workstation implementing the invention will contain an I/O device in the form of a communication adapter, 410, to connect to the personal assistant, 411. Adapter 410 might also connect directly to the public network if there were no personal assistant function, or if the server of FIG. 4 performed this function. The server also contains an additional communication adapter, 414, to provide the interface to the cellular radio exchange. In some embodiments it might interface to a PBX, or both. There may also be additional communication adapters. An optional display adapter 415 is shown connected to display 416. While not used in normal operation, a mobility server might have a display at times to be used for set-up, trouble-shooting, etc. Also, any of these adapters should be thought of as functional elements more so than discrete pieces of hardware. A server implementing the invention could have all or some of the adapter entities implemented together on one circuit board. It should be noted that the system of FIG. 4 is meant as an illustrative example only. Numerous types of computer systems, instruction execution systems, or workstations are available and can be used. Available systems include those that run operating systems such as Windows™ by Microsoft, various versions of UNIX™, various versions of LINUX™, and various versions of Apple's MaC™OS.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium or use by or in connection with the instruction execution system. Such mediums are pictured in FIG. 4 to represent the removable drive, and the hard disk. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and the hardware described in FIG. 4 form the various means for carrying out the functions of the invention in the example embodiments.

Specific embodiments of an invention are described herein. One of ordinary skill in the telecommunication arts will quickly recognize that the invention has other applications in other environments. In fact, many embodiments and implementations are possible. The appended claims are not intended to limit the scope of the invention to the specific embodiments described above. In addition, the recitation “means for” is intended to evoke a means-plus-function reading of an element in a claim, whereas, any elements that do not specifically use that recitation are not intended to be read as means-plus-function elements, even if they otherwise include the word “means.” I claim:

1. A method of providing a three-party calling function to an identified remote user, the method comprising:
establishing a first connection between the identified remote user and a second party;
receiving a command from the identified remote user to invoke the three-party calling function;
receiving an identifier from the identified remote user, the identifier corresponding to a third party;
establishing a second connection between at least the identified remote user and the third party;
confirming the second connection to the identified remote user; and
executing the three-party calling function in response to a user selection.

2. The method of claim 1 wherein the command is a voice command.

3. The method of claim 1 wherein the command is a dual tone multi-frequency (DTMF) command.

4. The method of claim 3 wherein the DTMF command is an individual DTMF signal from a special key on a wireless phone.

5. The method of claim 1 wherein the three-party calling function is at least a conference call between at least the identified remote user, the second party, and the third party.

6. The method of claim 2 wherein the three-party calling function is at least a conference call between at least the identified remote user, the second party, and the third party.

7. The method of claim 3 wherein the three-party calling function is at least a conference call between at least the identified user, the second party, and the third party.

8. The method of claim 4 wherein the three-party calling function is at least a conference call between at least the identified user, the second party, and the third party.

9. A computer program product including a computer program for enabling a server in a communication system to provide a three-party calling function to an identified remote user, the computer program comprising:
instructions for establishing a first connection between the identified remote user and a second party;
instructions for receiving a command from the identified remote user to invoke the three-party calling function;
instructions for receiving an identifier from the identified remote user, the identifier corresponding to a third party;
instructions for establishing a second connection between at least the identified remote user and the third party;
instructions for confirming the second connection to the identified remote user; and
instructions for executing the three-party calling function in response to a user selection.

10. The computer program product of claim 9 wherein the instructions for receiving a command further comprise instructions for receiving a voice command.

11. The computer program product of claim 9 wherein the instructions for receiving a command further comprise instructions for receiving a dual tone multi-frequency (DTMF) command.

12. The computer program product of claim 11 wherein the instructions for receiving a DTMF command further comprise instructions for receiving an individual DTMF signal from a special key on a wireless phone.

13. The computer program product of claim 9 wherein the three-party calling function is at least a conference call between at least the identified remote user, the second party, and the third party.

14. The computer program product of claim 10 wherein the three-party calling function is at least a conference call between at least the identified remote user, the second party, and the third party.

15. The computer program product of claim 11 wherein the three-party calling function is at least a conference call between at least the identified user, the second party, and the third party.

16. The computer program product of claim 12 wherein the three-party calling function is at least a conference call between at least the identified user, the second party, and the third party.

17. Apparatus for providing three-party calling function to an identified remote user of a communication system, the apparatus comprising:
means for establishing a first connection between the identified remote user and a second party;
means for receiving, from the identified remote user, a command to invoke the three-party calling function and an identifier corresponding to a third party;
means for establishing a second connection between at least the identified remote user and the third party; and
means for executing the three-party calling function.

18. The apparatus of claim 17 wherein the three-party calling function is at least a conference call between at least the identified remote user, the second party, and the third party.

19. A server for providing remote three-party calling function to an identified user of a communication system, the server comprising:
an first interface operable to connect to at least one private exchange for communicating with users of the communication system;
a second interface operable to provide access to at least one public network, through which the identified user communicates with the server; and
a processor system operable to control the operation of the server to establish a first connection between the identified user and a second party, to receive commands from the identified user to invoke the remote three-party calling function in relation to a third party, to establish a second connection between at least the identified remote user and the third party and to execute the remote three-party calling function.

20. The server of claim 19 wherein the at least one private exchange comprises a cellular radio exchange.

21. The server of claim 20 wherein the second interface provides access to the at least one public network through a personal assistant which is operable to identify the identified user.

22. The server of claim 19 wherein the remote three-party calling function is at least a conference call between at least the identified user, the second party, and the third party.

23. The server of claim 20 wherein the remote three-party calling function is at least a conference call between at least the identified user, the second party, and the third party.

24. The server of claim 21 wherein the remote three-party calling function is at least a conference call between at least the identified user, the second party, and the third party.

25. A communication system comprising:
at least one private exchange operable to relay communication signals between users of the communication system;
a personal assistant operable to identify a remote user and grant access to the remote user to place calls through the communication system from a remote location; and
a mobility server operatively connected to the at least one private exchange and the personal assistant, the mobility server further operable to provide remote three-party calling function to the remote user by establishing a first connection between the remote user and a second party, receiving commands from the remote user to invoke the three-party calling function in relation to a third party, and establishing a second connection between at least the remote user and the third party.

26. The communication system of claim 25 wherein the at least one private exchange further comprises a cellular radio exchange.

27. The communication system of claim 25 wherein the remote three-party calling function is at least a conference call between at least the remote user, the second party, and the third party.

28. The communication system of claim 26 wherein the remote three-party calling function is at least a conference call between at least the remote user, the second party, and the third party.
